(19) United States
(12) Patent Application Publication
(10) Pub. No.: US 2003/0220758 A1
(43) Pub. Date: Nov. 27, 2003

(54) Method for testing an AD-converter

(75) Inventors: Kazuhiro Nishimura, Tokyo (JP); Eisaku Yamashita, Tokyo (JP)

Correspondence Address: McDermott, Will & Emery, 600 13th Street, N.W., Washington, DC, 20005-3096, US

(73) Assignee: MITSUBISHI DENKI KABUSHIKI KAISHA

(21) Appl. No.: 10/295,924

(22) Filed: Nov. 18, 2002

(30) Foreign Application Priority Data
May 21, 2002 (JP) 2002-146829

(51) Int. Cl. G06F 19/00

(52) U.S. Cl. 702/117

(57) ABSTRACT

A voltage supply circuit having a voltage source and a voltage integration circuit supplies to an AD converter (ADC) an analog input voltage that linearly increases as time elapses. The ADC converts the analog input voltage to a digital output code. The digital output code is input to a timer circuit. As the input voltage increases with time, the ADC comes to output another digital output code. This digital output code is also input to the timer circuit. Therefore, the timer circuit can measure a time interval between moments when the digital output code changes. The timer circuit may calculate a difference of the input voltage based on the measured time interval according to a prescribed formula. Linearity or other electrical characteristics of the ADC can be evaluated by repeating such a time interval measurement and a calculation of the input voltage for all changes of the digital output code.

### BACKGROUND OF THE INVENTION

1. Field of the Invention

The present invention relates to a method for testing linearity of an AD converter that converts an analog input voltage into a digital output code.

2. Background Art

Conventional methods to test linearity of an AD converter (ADC) require an analog voltage generation circuit that generates an arbitrary voltage with high accuracy at a high resolution. FIG. 5 is a block diagram of a conventional ADC testing circuit 100 that includes an ADC 82 to be tested and an IC tester 90 for testing the ADC 82. In FIG. 5, reference numeral 80 denotes an above-mentioned, expensive analog voltage generation circuit for generating an arbitrary voltage with high accuracy at a high resolution. Reference numeral 82 denotes the ADC to be tested to which an arbitrary voltage is applied by the analog voltage generation circuit 80. Reference numeral 81 denotes a voltage input terminal of the ADC 82. Reference numeral 84 denotes a digital output code acquisition circuit for acquiring a digital output code that is produced by analog-to-digital conversion by the ADC 82. Reference numeral 86 denotes a controller for controlling the analog voltage generation circuit 80 and the digital output code acquisition circuit 84. As shown in FIG. 5, the IC tester 90 is composed of the analog voltage generation circuit 80, the digital output code acquisition circuit 84, and the controller 86.

IC tester 90 controls the analog voltage generation circuit 80 and causes it to apply an arbitrary analog voltage to the voltage input terminal 81 of the ADC 82 to be tested shown in FIG. 5. Then, based on a function test function, the IC tester 90 causes the digital output code acquisition circuit 84 to acquire a digital output code that is produced by the ADC 82 by AD conversion. Then, the IC tester 90 performs a comparative judgment etc. on the acquired digital output code. In this manner, the IC tester 90 can obtain an AD-converted code (digital output code) that is produced by the ADC 82 when an arbitrary analog voltage is applied to it. Further, the IC tester 90 causes the digital output code acquisition circuit 84 to acquire digital output codes sequentially from the ADC 82 by varying the input analog voltage that is applied to the ADC 82 by a prescribed potential difference each time. By repeating this processing, the IC tester 90 acquires digital output codes for respective input analog voltages. The acquired digital output codes are analyzed, whereby an analog input voltage is detected that corresponds to a variation point from one digital output code to another. In this manner, linearity of the ADC 82 is evaluated.

In the conventional ADC testing circuit 100, measurements are performed by varying the analog input voltage at such a resolution setting that several to tens of variation steps of the analog input voltage correspond to a potential difference of the analog input voltage that is expected to cause a one-code change in the digital output code that is output from the ADC 82. As a result, the analog voltage generation circuit 80 is required to have a high-resolution function and a memory circuit is needed that has an enormous capacity that enables storage of digital output codes that are output from the ADC 82 sequentially.

As described above, because of the use of the ADC testing circuit 100 shown in FIG. 5, the conventional ADC testing method requires the analog voltage generation circuit 80 that generates an arbitrary voltage with high accuracy at a high resolution. However, there is a problem that the analog voltage generation circuit 80 is generally expensive and hence the ADC test is costly. Further, where the high-accuracy, high-resolution analog voltage generation circuit 80 shown in FIG. 5 is used, setting of a power circuit takes time. In addition, a test cannot be performed in a stable manner until the analog input voltage becomes stable. That is, waiting is necessary until the analog input voltage settles at a setting value correctly and stably. This means a problem that an ADC test takes long time.

### SUMMARY OF THE INVENTION

The present invention has been made to solve the above problems, and an object of the invention is therefore to provide a testing method capable of conducting an ADC test in a shorter time than in conventional cases without using an expensive analog voltage generation circuit that is highly accurate and has a high resolution.

According to the testing method of the present invention, a voltage supply circuit that includes a voltage source and a voltage integration circuit is used. The voltage supply circuit supplies an analog input voltage that linearly increases as time elapses to the AD converter. A digital code that is output from the AD converter is supplied into a timer circuit. The timer circuit obtains, by measuring or calculating, time intervals between moments when a digital code output from the AD converter changes to a next code. An electrical characteristic such as linearity of the AD converter can be evaluated based on the obtained time intervals.

Other and further objects, features and advantages of the invention will appear more fully from the following description.

### BRIEF DESCRIPTION OF THE DRAWINGS

The present invention will be more apparent from the following detailed description, when taken in conjunction with the accompanying drawings, in which;

FIG. 1 is a block diagram of an ADC testing circuit according to a first embodiment of the invention;

FIG. 2A is a graph showing how the input voltage V₀ (ordinate) that is applied to the input terminal of the ADC varies with respect to the elapsed time t (abscissa);

FIG. 2B shows how the digital output code varies with respect to the elapsed time t in FIG. 2A;

FIG. 3 is a block diagram of an ADC testing circuit according to a second embodiment;

FIG. 4 is a flowchart showing the ADC testing method according to a third embodiment of the invention;

FIG. 5 is a block diagram of a conventional ADC testing circuit.

### DETAILED DESCRIPTION OF THE PREFERRED EMBODIMENTS

Embodiments of the present invention will be hereinafter described in detail with reference to the accompanying drawings.

First Embodiment

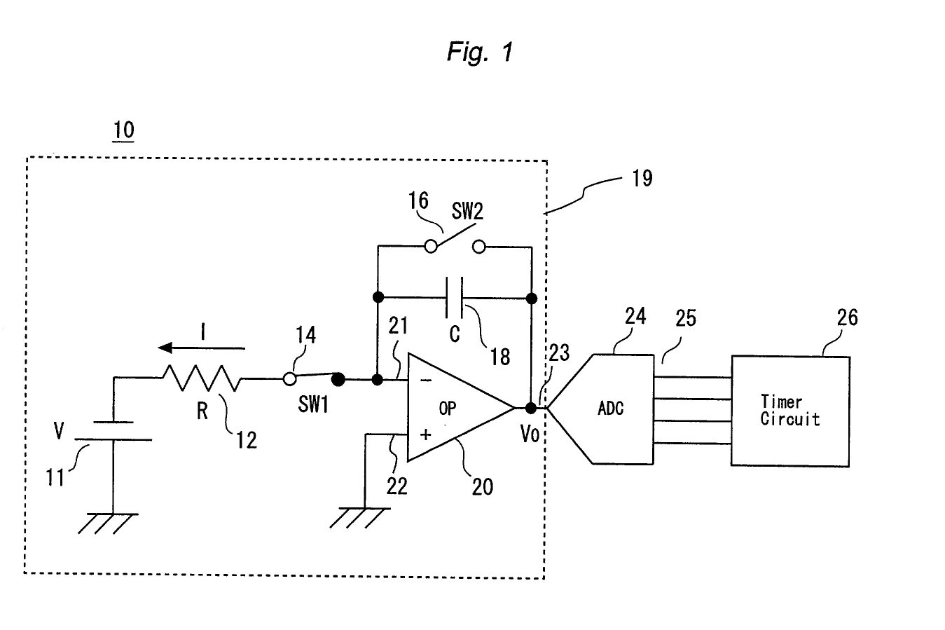

FIG. 1 is a block diagram of an ADC testing circuit 10 according to a first embodiment of the invention that tests an ADC 24 to be tested.

In FIG. 1, reference numeral 19 denotes a voltage supply circuit. Reference numeral 11 denotes a voltage source of a voltage V into which a current I flows. Reference numeral 12 denotes a resistor having a resistance R that is connected to one end of the voltage source 11. Reference numeral 14 denotes a relay switch SW1 that is connected to the other end of the resistor 12. Reference numeral 20 denotes an operational amplifier having an operational amplification function. The relay switch SW1 (14) is connected to an inverting input terminal 21 of the operational amplifier 20 and its non-inverting input terminal 22 is grounded. Reference numeral 18 denotes a capacitor having a capacitance C that is provided between the inverting input terminal 21 and the output terminal of the operational amplifier 20. Reference numeral 16 denotes a relay switch SW2 that is connected to the capacitor 18 in parallel. As shown in FIG. 1, the voltage supply circuit 19 having a voltage integration circuit according to the first embodiment of the invention includes the voltage source 11, the resistor 12, the relay switches SW1 (14) and SW2 (16), the capacitor 18, and the operational amplifier 20.

Reference numeral 24 is an ADC to be tested whose input terminal 23 is connected to the output terminal of the operational amplifier 20. Reference numeral 26 denotes a timer circuit that receives a digital output code from output terminals 25 of the ADC 24.

As is understood from FIG. 1, when the relay switch SW1 (14) is turned on and the relay switch SW2 (16) is turned off, the operational amplifier 20 starts a voltage integration operation and an analog input voltage (hereinafter referred to simply as “input voltage”) is supplied from the voltage supply circuit 19 to the ADC 24. The ADC 24 AD-converts the input voltage that is applied to the input terminal 23 and outputs a digital output code from the output terminals 25. The digital output code is input to the timer circuit 26. As the input voltage that is applied to the input terminal 23 of the ADC 24 increases with time, the ADC 24 comes to output another digital output code from the output terminals 25. This digital output code is also input to the timer circuit 26. Therefore, the timer circuit 26 can measure a time interval at which the digital output code changes. A variation in the input voltage (i.e., a potential difference) can be calculated based on the time interval measured by the timer circuit 26 according to a prescribed formula (described later). Linearity or other electrical characteristics of the ADC 24 can be evaluated using the calculated values.

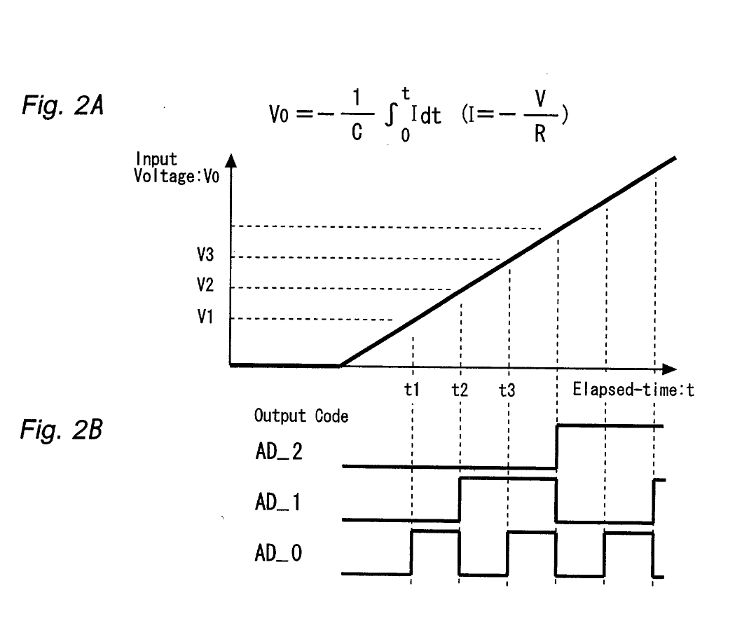

FIGS. 2A and 2B illustrate how the digital output code varies as the input voltage that is applied to the ADC 24 of the ADC testing circuit 10 of FIG. 1 varies. FIG. 2A is a graph showing how the input voltage V₀ (ordinate) that is applied to the input terminal 23 of the ADC 24 varies with respect to the elapsed time t (abscissa) from a time point when the relay switch SW1 (14) is turned on and the relay switch SW2 (16) is turned off. FIG. 2B shows how the digital output code varies with respect to the elapsed time t in FIG. 2A. FIG. 2B shows an example in which 3-bit codes are used (AD_{—}2, AD_{—}1, and AD_{—}0).

As shown in the graph of FIG. 2A, the input voltage V1 that is applied to the input terminal 23 of the ADC 24 to be tested, that is the output voltage V₀ of the operational amplifier 20, increases in order of 0, V1, V2, and V3 as the time t elapses in order of 0, t1, t2, and t3. As shown in FIG. 2B, the digital output code that is output from the output terminals 25 varies in such a manner that AD_{—}2=0, AD_{—}1=0, and AD_{—}0=0 (code “000”; an expression “code” will be hereinafter employed) when t=0, code “001” occurs when t=t1, code “010” occurs when t=t2, and code “011” occurs when t=t3. In other words, the output voltage V1 is a value of the voltage V₀ at which the digital output code changes from code “000” to code “001” and time t1 is an elapsed time to that event. Similarly, the output voltage V2 is a value of the voltage V₀ at which the digital output code changes from code “001” to code “010” and time t2 is an elapsed time to that event. The output voltage V3 is a value of the voltage V₀ at which the digital output code changes from code “010” to code “011” and time t3 is an elapsed time to that event. The output voltage V₀ is given by Formula (1) by using the capacitance C of the capacitor 18 and a current I (=−V/R) flowing through the voltage source 11 of the voltage V:

$$V0 = - \frac{1}{C} {\int }_{0}^{t} I ⅆ t where I = - \frac{V}{R} \qquad ( 1 )$$

Therefore, the output voltages V1 and V2 are given by Formulae (2) and (3), respectively:

$$\begin{matrix}V1 = - \frac{1}{C} {\int }_{0}^{t1} I ⅆ t where I = - \frac{V}{R} & ( 2 ) \\ V2 = - \frac{1}{C} {\int }_{0}^{t2} I ⅆ t where I = - \frac{V}{R} & ( 3 )\end{matrix}$$

The difference between the output voltages V1 and V2, that is, a variation in the output voltage V₀ corresponding to one LSB (least significant bit) of the output code of the ADC 24, is given by Formula (4), which is obtained from Formulae (2) and (3):

$$V2 - V1 = - \frac{1}{C} {\int }_{t1}^{t2} I ⅆ t = - \frac{I}{C} ( t2 - t1 ) where I = - \frac{V}{R} \qquad ( 4 )$$

That is, a variation in the output voltage V₀ corresponding to one LSB of the digital output code of the ADC 24 can be calculated based on (t2−t1) which is a time interval between time t1 and t2 that is taken by the digital output code to change. Therefore, a test on an electrical characteristic such as the differential linearity error of the ADC 24 can be performed by connecting, to the output terminals 25 of the ADC 24, the timer circuit 26 capable of measuring a time interval at which the digital output code changes. More specifically, a potential difference that causes a change from code “001” to code “010” can be calculated by measuring a time interval between time t1 and t2. Similarly, a potential difference that causes a change from code “010” to code “011” can be calculated by measuring a time interval between time t2 and t3. By repeating such a time difference measurement, time intervals between adjacent codes from code “000” to the highest code can be acquired and hence the electrical characteristic test can be performed for all changes of the digital output code.

The variation rate of the voltage V₀ can be controlled by the capacitance C of the capacitor 18 or the current I (i.e., the resistance R of the resistor 12 because I=−V/R) flowing through the regulated power source (voltage source) 10. Therefore, where the accuracy of the timer circuit 26 is insufficient, the capacitance C or the resistance R may be increased. In this manner, sufficiently accurate measurements can be performed even with a simple timer circuit 26.

As described above, according to the first embodiment, it is not necessary to use an expensive voltage generation circuit that is highly accurate and has a high resolution to generate an input voltage that is to be applied to the input terminal 23 of the ADC 24 to be tested. A potential difference that causes a change of the digital output code that is output from the output terminals 25 of the ADC 24 can be calculated according to Formula (4) by measuring, with the timer circuit 26, a time interval that is taken by the digital output code to make the change. That is, an electrical characteristic test can be performed without using an expensive voltage generation circuit that is highly accurate and has a high resolution. Further, there does not occur a waiting time that is necessary with an expensive voltage generation circuit that is highly accurate and has a high resolution. An ADC test can be performed in a shorter time.

Second Embodiment

The first embodiment is directed to the case that a time interval at which the digital output code changes that is output from the output terminals 25 of the ADC 24 to be tested. A second embodiment of the invention is directed to a testing circuit which records such time intervals.

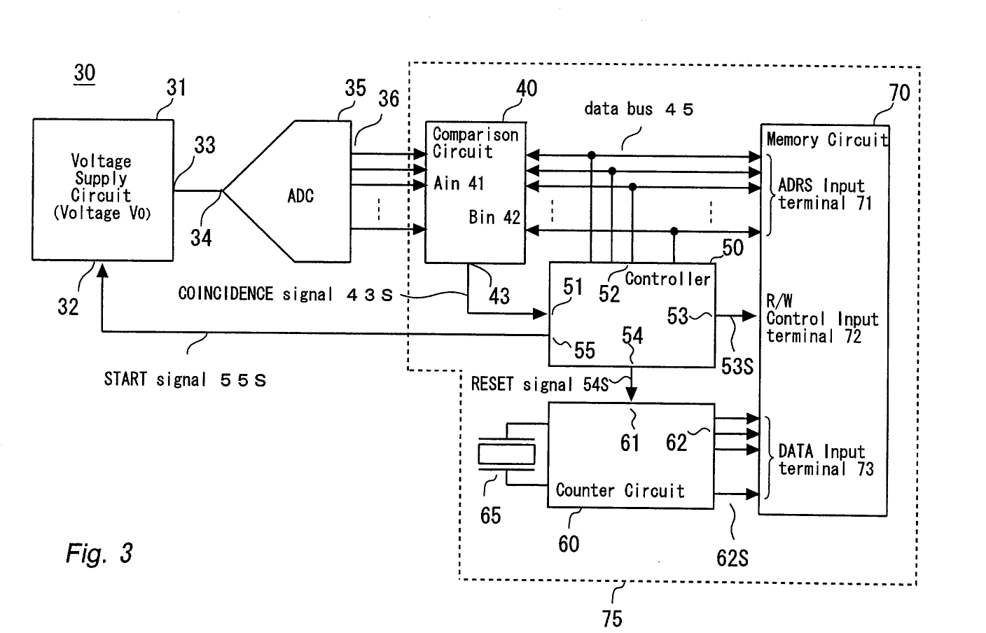

FIG. 3 is a block diagram of an ADC testing circuit 30 according to the second embodiment for testing an ADC 35 to be tested. In FIG. 3, reference numeral 31 denotes a voltage supply circuit that is similar in circuit configuration to the voltage supply circuit 19 having a voltage integration circuit according to the first embodiment. Reference numeral 33 denotes a voltage output terminal of the voltage supply circuit 31. In circuit configuration, the voltage supply circuit 31 having a voltage integration circuit according to the second embodiment includes the voltage source 11, the resistor 12, the relay switches SW1 (14) and SW2 (16), the capacitor 18, and the operational amplifier 20 that are shown in FIG. 1. In addition, the voltage supply circuit 31 has a start signal input terminal 32 for receiving a start signal 55S to be used for controlling tuning-on of the relay switch SW1 (14) and turning-off of the relay switch SW2 (16). Reference numeral 35 denotes an ADC to be tested and reference numerals 34 and 36 denote an input terminal and an output terminal, respectively, of the ADC 35. A voltage is supplied from a voltage output terminal 33 of the voltage supply circuit 31 to the input terminal 34, and a digital output code is output from the output terminal 36.

Part (enclosed by a broken line) of the ADC testing circuit 30 of FIG. 3 is a timer circuit 75 that measures, as a count, a time interval that is taken by the above digital output code to change to the next code and records the count with the next digital output code as an address. In the second embodiment, a potential difference of the input voltage of the ADC 35 is calculated based on the count according to Formula (5) (described later). Linearity or other electrical characteristics of the ADC 24 can be evaluated using the calculated values.

The timer circuit 75 will be described below. Reference numeral 40 denotes a comparison circuit that compares a digital output code that is received from the output terminal 36 of the ADC 35 with a prescribed code that is received from a data bus 45. If they coincide with each other, the comparison circuit 40 outputs, at a coincidence signal output terminal 43, a coincidence signal 43S, which is supplied to a controller 50 (described later). The digital output code is input to input terminals Ain (41) of the comparison circuit 40, and the prescribed code is supplied from the controller 50 to input terminals Bin (42) of the comparison circuit 40 as comparison data.

Reference numeral 65 denotes a reference clock generation circuit that generates a reference clock having an oscillation frequency f. Reference numeral 60 denotes a counter circuit that receives, at a reset signal input terminal 61, a reset signal 54S that is supplied from the controller 50. The counter circuit 60 thereafter counts reference clock pulses having a predetermined duration that are generated by the reference clock generation circuit 65. The counter circuit 60 outputs, at count output terminals 62, a resulting count N, which is supplied to a memory circuit 70 (described later) as a count signal 62S.

When receiving a write signal 53S at a read/write (R/W) control input terminal 72, the memory circuit 70 records a count N that is received from the counter circuit 60 with arbitrary timing at data (DATA) input terminals 73 in such a manner that the count N is associated with a prescribed code as an address that is received from the data bus 45 at address (ADRS) input terminals 71. The prescribed code is comparison data that is output from the controller 50 to the data bus 45.

The controller 50 outputs, at a start signal output terminal 55, a start signal 55S, which is supplied to the voltage supply circuit 31 having a voltage integration circuit. The controller 50 outputs, at data bus output terminals 52, a prescribed code (comparison data), which is supplied to the data bus 45. The controller 50 also outputs, at a reset signal output terminal 54, a reset signal 54S, which is supplied to the counter circuit 60. When receiving, at a coincidence signal input terminal 51, a coincidence signal 43S that is supplied from the comparison circuit 40, the controller 50 outputs, at a write signal output terminal 53, a write signal 53S, which is supplied to the memory circuit 70.

Next, the operation of the ADC testing circuit according to the second embodiment will be described. As shown in FIG. 3, first, the controller 50 supplies a start signal 55S to the voltage supply circuit 31. As a result, the potential V₀ of the voltage output terminal 33 of the voltage supply circuit 31 starts increasing. Then, the controller 50 supplies code “001” to the input terminals Bin (42) of the comparison circuit 40 and the ADRS input terminals 71 of the memory circuit 70 via the data bus 45 to set comparison data (code “001”) and an address (code “001”). At the same time, the controller 50 supplies a reset signal 54S to the counter circuit 60.

When receiving the reset signal 54S, the counter circuit 60 resets the count N to “0.” The counter circuit 60 thereafter starts counting pulses of a reference clock that is supplied from the reference clock generation circuit 65.

At first, code “000” is output from the output terminals 36 of the ADC 35 to be tested. As the potential V₀ that is applied to the input terminal 34 increases with time, the digital output code changes from code “000” to code “001.”

Therefore, the digital output code that is input to the input terminals Ain 41 of the comparison circuit 40 also changes to code “001.” As a result, the digital output code that is input to the input terminals Ain 41 comes to coincide with the comparison data (code “001”) that was input to the input terminals Bin 42. The comparison circuit 40 supplies a coincidence signal 43S to the controller 50.

Receiving the coincidence signal 43S, the controller 50 supplies a write signal 53S to the memory circuit 70.

Receiving the write signal 53S, the memory circuit 70 records a count N that is supplied from the counter circuit 60 at a position that has been set as the above-mentioned address (code “001”).

As described above, a time interval at which the digital output code that is output from the ADC 35 changes from code “000” to code “001” can be measured as a count N and the count N can be recorded in the memory circuit 70 with code “001” as an address.

Then, the controller 50 adds “1” to the value of code “001” and outputs code “010” to the data bus 45. In the ADC testing circuit 30, a series of operations that is similar to the one described above is performed. A new count N can be recorded in the memory circuit 70 at another address (code “010”). The controller 50 performs the series of operations until counts N corresponding to all digital output codes of the ADC 35 are recorded in the memory circuit 70.

After completion of the above process, potential differences ΔV of the input voltage of the ADC 35 can be calculated based on the counts N corresponding to the respective digital output codes that are recorded in the memory circuit 70. Since the oscillation frequency f of the reference clock is known, a time interval Δt at which the digital output code of the ADC 35 changes can be calculated based on the associated count N according to the following Formula (5):

Δt=N/f (5)

Formula (6) can be obtained by rewriting (V2−V1) and (t2−t1) in Formula (4) to ΔV and Δt, respectively, and substituting Δt of Formula (5) into Formula (4):

ΔV=−(I/C)×N/f (6)

In this manner, potential differences ΔV of the input voltage of the ADC 35 can be calculated.

As described above, by using the ADC testing circuit 30 according to the second embodiment, a count N corresponding to a time interval Δt at which the digital output code of the ADC 35 to be tested can be recorded in the memory circuit 70. The time interval Δt can be obtained based on the count N according to Formula (5), and a potential difference ΔV of the input voltage of the ADC 35 can further be calculated based on the thus-obtained time interval Δt according to Formula (6). Linearity or other electrical characteristics of the ADC 35 can be evaluated using the calculated potential difference ΔV.

The memory circuit 70 merely records a count N that is obtained when the digital output code changes. Therefore, unlike the case of conventional ADC testing circuits, it is not necessary to record digital output codes each of which is output for several to tens of steps of the input voltage. As a result, the storage capacity of the memory circuit 70 can be made smaller than in the conventional case by a factor of 2 to several tens.

The voltage supply circuit 31 having a voltage integration circuit can be mounted on an interface board for interfacing between the ADC 35 and the timer circuit 75.

Third Embodiment

A third embodiment of the invention is directed to a novel testing method to test linearity of the ADC 24 or 35 to be tested or the like by using a function of a conventional IC tester. The function of a conventional IC tester is a function of realizing a process (hereinafter referred to as “matching control”) of repeating a series of function test operation (function operations) until a digital output code that is output from arbitrary digital output code output terminals of an IC to be tested coincides with a comparison code of the IC tester, as well as recording the number of times of repetition.

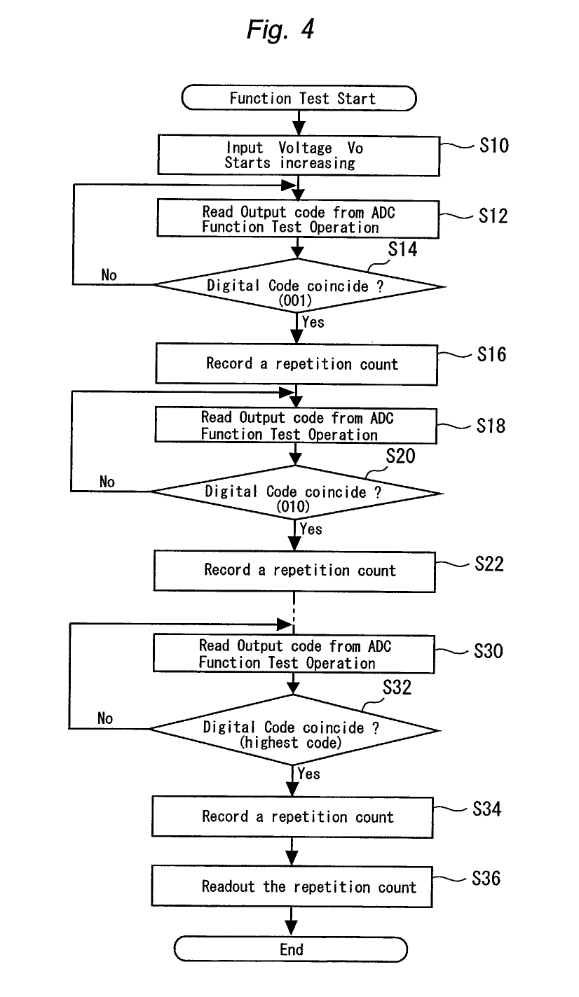

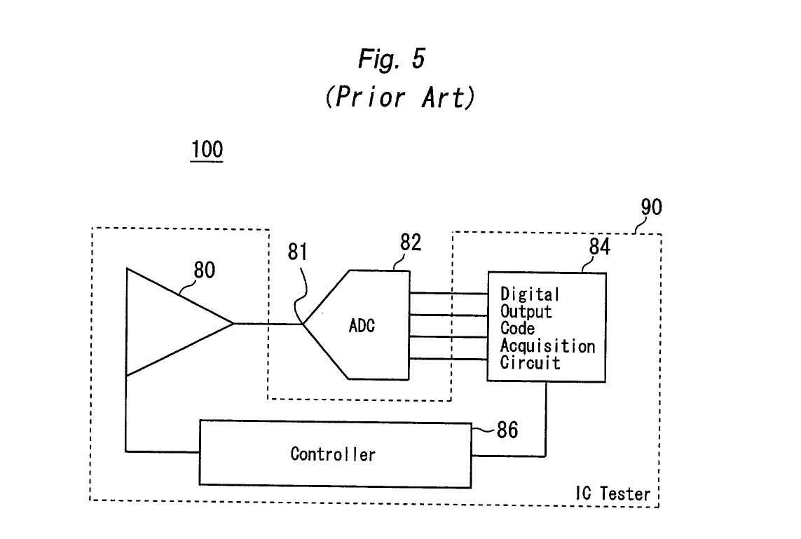

In the ADC testing method according to the third embodiment, the voltage supply circuit having a voltage integration function according to the first embodiment that is shown in FIG. 1 is employed and the voltage supply circuit is mounted on a DUT (device under test) board or the like. An ADC test is performed on an ADC to be tested according to a flowchart of FIG. 4. It is assumed that the above-mentioned arbitrary digital output code output terminals correspond to the output digital output code terminals of the ADC, and that code “001” to the highest code of the ADC are prepared as comparison codes of the IC tester. Function test operations of matching control correspond to control on an AD conversion operation of the ADC.

FIG. 4 is a flowchart showing the ADC testing method according to the third embodiment of the invention. As shown in FIG. 4, first, a start signal is generated by the function test control function of the IC tester, whereupon the voltage V₀ that is output from the voltage supply circuit having a voltage integration circuit starts increasing (step S10). Code “001” is set as an expectation value of the digital output code that is output from the ADC and first matching control is performed. The IC tester reads a digital output code of the ADC and performs a prescribed function test operation (i.e., control on an AD conversion operation of the ADC) (step S12). Then, the IC tester judges whether the digital output code of the ADC coincides with code “001” (step S14). The IC tester repeats steps S12 and S14 until the digital output code of the ADC coincides with code “001.” If the digital output code of the ADC coincides with code “001,” the IC tester reads the number of times of repetition (i.e., a repetition count) and records it in a prescribed memory circuit (step S16).

Then, code “010” is set as an expectation value of the digital output code that is output from the ADC and matching control similar to the above is performed (steps S18, S20, and S22). The series of operations is repeated until the digital output code of the ADC comes equal to the highest code (having a value “1” in all bits) (steps S30 and S32) and a corresponding repetition count is recorded (step S34). Then, the recorded repetition count is read out (step S36), whereupon the ADC test is finished.

Let N, M, and T represent the repetition count (the number of times of repetition), the number of cycles necessary for control on an AD conversion operation of the ADC in each repetition, and a one-cycle time, respectively. The time interval Δt at which the digital output code changes is given by the following Formula (7):

Δt=N×M×T (7)

A formula similar to Formula (6) of the second embodiment can be obtained by substituting Δt of Formula (7) into Formula (4). A potential difference ΔV of the input voltage of the ADC can be calculated in the above-described manner.

As described above, according to the third embodiment, an ADC test can be performed on an ADC to be tested by using a conventional IC tester having a function of realizing matching control and recording the number of times of repetition in the matching control. More specifically, the voltage supply circuit having a voltage integration function according to the first embodiment that is shown in FIG. 1 is employed and the voltage supply circuit is mounted on a DUT board or the like. An ADC test is performed on an ADC to be tested according to the flowchart of FIG. 4. As a result, an IC tester not having a high-functionality analog measurement circuit can be used for an electrical characteristic test on an ADC.

As described above, according to the testing method and the testing circuit described above, it is not necessary to use an expensive voltage generation circuit that is highly accurate and has a high resolution to generate an input voltage that is to be applied to the input terminal 23 of an ADC 24 to be tested. A potential difference that causes a change of the digital output code that is output from the output terminals 25 of the ADC 24 to be tested can be calculated according to Formula (4) by measuring, with a timer circuit 26, a time interval that is taken by the digital output code to make the change. That is, an electrical characteristic test can be performed without using an expensive voltage generation circuit that is highly accurate and has a high resolution. Further, there does not occur a waiting time that is necessary with an expensive voltage generation circuit that is highly accurate and has a high resolution. An ADC test can be performed in a shorter time.

It is further understood that the foregoing description is a preferred embodiment of the disclosed method and circuit and that various changes and modifications may be made in the invention without departing from the spirit and scope thereof.

The entire disclosure of a Japanese Patent Application No.2002-146829, filed on May 21,2002 including specification, claims drawings and summary, on which the Convention priority of the present application is based, are incorporated herein by reference in its entirety.

1. A method for testing an AD converter comprising the steps of:
supplying an analog input voltage that linearly increases as time elapses to the AD converter by a voltage supply circuit including a voltage source and a voltage integration circuit;
supplying a digital code that is output from the AD converter into a timer circuit;
obtaining, by the timer circuit, time intervals between variation points when a digital code output from the AD converter changes to a next code; and
evaluating an electrical characteristic of the AD converter based on the obtained time intervals.

2. The method for testing an AD converter according to claim 1, wherein the voltage integration circuit comprises:
a resistor having one end that is connected to the voltage source through which a current I flows;
an operational amplifier having an operational amplification function and having an inverting input terminal that is connected the other end of the resistor; and
a capacitor having a capacitance C that is provided between the inverting input terminal and an output terminal of the operational amplifier.

3. The method for testing an AD converter according to claim 2, wherein the evaluating step comprises the steps of:
calculating a potential difference of the analog input voltage according to a prescribed formula, the formula is
Vᵢ₊₁−Vᵢ=−(I/C) (tᵢ₊₁−tᵢ)
where assuming that after the operational amplifier starts a voltage integration function at time 0, at time tᵢ the analog input voltage becomes Vᵢ and the digital output code changes to a first code and at time tᵢ₊₁ the analog input voltage becomes Vᵢ₊₁ and the digital output code changes from the first code to a second code;
evaluating an electrical characteristic of the AD converter based on the potential differences of the analog input voltage.

4. The testing method according to claim 1, further comprises the step of:
recording the obtained time intervals so as to be correlated with the digital output codes.

5. The testing method according to claim 1, wherein the timer circuit comprises:
a comparison circuit for comparing the digital output code that is output from the AD converter with a prescribed code that is received from a data bus, and for outputting a coincidence code if the digital output code coincides with the prescribed code;
a reference clock generator for generating a reference clock at an oscillation frequency f;
a counter circuit for counting pulses of the reference clock upon receiving a reset signal;
a memory circuit for recording, upon receiving a write signal, a count N that is received from the counter circuit with the prescribed code as an address, the prescribed code being received from the data bus;
a controller for supplying a start signal to the voltage integration circuit, outputting the prescribed code to the data bus, supplying the reset signal to the counter circuit, and supplying the write signal to the memory circuit upon receiving the coincidence signal from the comparison circuit; and
a calculator that calculates the time interval Δt according to a formula Δt=N/f.

6. The testing method according to claim 1, wherein an IC tester is used as the timer circuit, that repeats a prescribed function operation until a digital output code that is output from IC to be tested coincides with a prescribed code, and records the number of times of repetition after the digital output code has coincided with the prescribed code.

7. The testing method according to claim 6, wherein a digital code that is output from the AD converter is supplied to the IC tester as the prescribed code, and the obtaining step comprises:
performing as the prescribed function operation, control on an AD conversion operation of the AD converter by the IC tester;
repeating the control on the AD conversion operation of the AD converter until the digital output code that is output from the AD converter coincides with the digital output code that is supplied to the IC tester;
recording the number of times of repetition so as to be correlated with the digital output code when the two digital output codes coincide with each other;
calculating the time interval Δt by a formula Δt=N×M×T, where N is the number of times of repetition, M is the number of cycles necessary for the control on the AD conversion operation of the AD converter in each repetition, and T is a one-cycle time; and
repeating the repetition of the control on the AD conversion operation and the recording of the number of times of repetition for all digital output codes that are output from the AD converter.

8. The testing method according to claim 6, wherein the voltage supply circuit is mounted on an interface board for interfacing between the AD converter and the IC tester.
